(19) United States
(12) Patent Application Publication
(10) Pub. No.: US 2020/0260915 A1
(43) Pub. Date: Aug. 20, 2020

(54) PORTABLE AND REMOVABLE ABLUTION STATION

(71) Applicant: Ibrahim ROZILAWATI, Petaling Jaya (MY)

(72) Inventor: Ibrahim ROZILAWATI, Petaling Jaya (MY)

(21) Appl. No.: 16/347,173

(22) PCT Filed: Oct. 27, 2017
(86) PCT No.: PCT/MY2017/000037

§ 371 Date: May 2, 2019

(30) Foreign Application Priority Data
Nov. 2, 2016 (MY) PI 2016704019

(51) Int. Cl. A47K 3/022; E03C 1/04; E03C 1/16; E03C 1/18

(52) U.S. Cl. CPC A47K 3/022; E03C 1/04; E03D 9/085; E03C 1/18; A61H 2201/0157; E03C 1/16

(57) ABSTRACT

The present invention relates to a portable and movable ablution station that is ergonomically designed for disabled and people with special needs that will help ease their lives in performing wudu independently and comfortably. The ablution station includes a support structure having a vertical platform and a bottom base. A washing platform is connected to an upper part of the vertical platform by a support means between the washing platform and the vertical platform allows water to flow from the washing platform to the bottom base. A fountain water system is fixed at the bottom base of the support structure for washing lower part of a user's body. A water inlet for allowing water flow from a water source is directed to the washing platform and to the fountain water system wherein a water tap is mounted on the washing platform for washing upper part of the user's body. A water controller is provided to control water flow from the water inlet to the fountain water system. A water outlet allows water drain from the ablution station.

### FIELD OF INVENTION

The present invention relates to an ablution station. More particularly, the ablution station is specially designed for disabled and people with special needs that will help ease their lives in performing wudu independently and comfortably.

### BACKGROUND OF THE INVENTION

Mosque has been among popular building that is visited frequently by disable and people with special needs other than general public. It remained as the main place where religious activities such as religious talks, reciting of Al-Quran and any other activities being placed for the Muslims to learn Islam.

Among the major problems faced by a disable person with a wheelchair at the mosque are the accessibility towards the ablution area and also the existing architectural design of ablution area does not cater a wheelchair user mostly due to insufficient space between the seats at ablution area that might cause obstruction to the wheelchair user to access ablution area. On the other hand, for people with special needs for example a pregnant woman or senior citizen, the existing ablution facilities is not user-friendly enough.

CA2561773 disclosed an ablution station comprises of drainage basin, seat, footrests, splash walls, step and drainage hole. IN2007DE02139 disclosed a basin which enables user to perform the rite of ablution while sitting down. However, both prior arts are unable to fulfill the requirement for a wheelchair user whereby the user have to seat on the provided seat and as a wheelchair user, it is difficult to transfer from the wheelchair to the provided seat and may need help from the other person to perform the ablution process. Furthermore, the fixed structure of the ablution station and basin requires a special space and cannot be moved and the moving process is very limited, difficult and yet very costly.

Thus, there is a need in the art to provide an ablution station which is portable and easy to install with an improved design to be suited to all kind of people especially for disable people or people with special needs.

### SUMMARY OF THE INVENTION

According to a first aspect of the present invention, there is provided a portable and movable ablution station comprises of a support structure having a vertical platform (10) and a bottom base (2); a washing platform (5) is connected to an upper part of the vertical platform (10) by a support means (4); an opening between the washing platform (5) and the vertical platform (10) for allowing water to flow from the washing platform (5) to the bottom base (2); a fountain water system (15) is fixed at the bottom base (2) of the support structure for washing lower part of a user's body; a water inlet (16) for allowing water flow from a water source is directed to the washing platform (5) and to the fountain water system (15) wherein a water tap (12) is mounted on the washing platform (5) for washing upper part of the user's body; a water controller (14) is provided to control water flow from the water inlet (16) to the fountain water system (15); and a water outlet (20) for allowing water drain from the ablution station.

Advantageously, the ablution station is suitable for a wheelchair user to perform ablution process independently and comfortably whilst remaining in their wheelchair.

Advantageously, the ablution station is ergonomically designed to prevent water from over spilling whilst providing comfort to the user to perform ablution process.

Advantageously, the transparent feature of the washing platform allows the user to look down when washing their feet.

Advantageously, the design of the ablution station is user-friendly and the user is no longer rely on others for assistance to perform ablution process.

Advantageously, the remote, oscillating, multidirectional fountain water system (15) features is beneficial to ensure stand-alone feature whereby a water controller (14) is provided to control the water flow from the water inlet (16) to the fountain water system (15).

Advantageously, the ready-to-assemble concept of installation avoids expensive installation and renovation of the existing facilities.

Advantageously, the double layer feature of the bottom base (2) is to avoid water ponding.

### BRIEF DESCRIPTION OF THE DRAWINGS

For a fuller understanding of the nature of the present invention, reference should be made to the following detailed description taken in connection with the accompanying drawings in which:

FIG. 1: illustrates a schematic drawing of the ablution station of the present invention.

FIG. 2: illustrates a schematic drawing of the water flow mechanism of the present invention.

### DETAILED DESCRIPTION OF THE PREFERRED EMBODIMENT

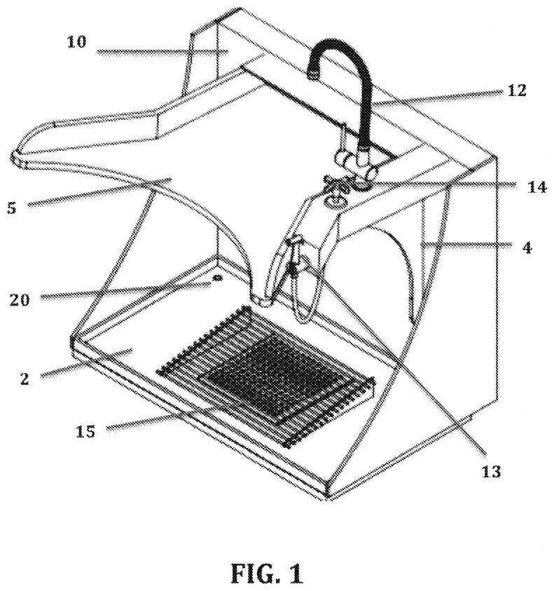

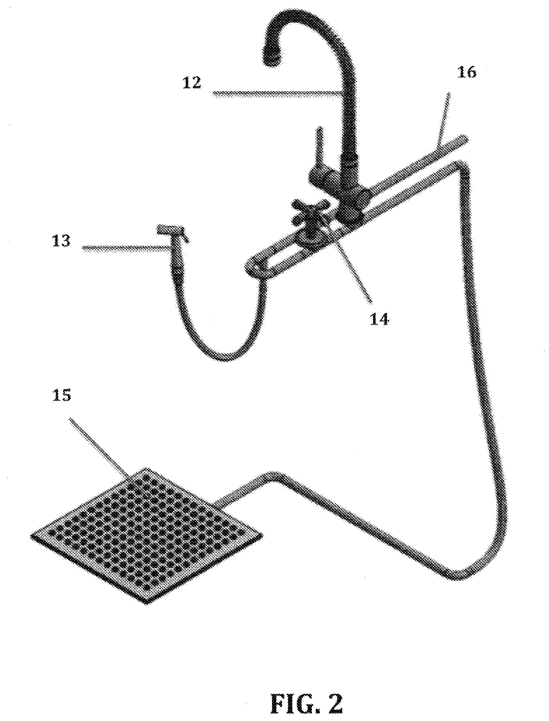

The present invention relates to a portable and movable ablution station. With reference to FIG. 1 and FIG. 2, the ablution station comprising a support structure having a vertical platform (10) and a bottom base (2); a washing platform (5) is connected to an upper part of the vertical platform (10) by a support means (4); an opening between the washing platform (5) and the vertical platform (10) for allowing water to flow from the washing platform (5) to the bottom base (2); a fountain water system (15) is fixed at the bottom base (2) of the support structure for washing lower part of a user's body; a water inlet (16) for allowing water flow from a water source is directed to the washing platform (5) and to the fountain water system (15) wherein a water tap (12) is mounted on the washing platform (5) for washing upper part of the user's body; a water controller (14) is provided to control water flow from the water inlet (16) to the fountain water system (15); and a water outlet (20) for allowing water drain from the ablution station.

In one embodiment, the washing platform (5) is designed ergonomically to prevent water from over spilling and suit for disable user with a wheelchair. In general, the whole structure of the ablution station has been ergonomically designed by considering anthropometry of various conditions of disabled community to suit the disabled and those who are wheelchair bound. The unique transparent washing platform (5) is ergonomically designed and allows the users to look down when washing their feet and provides comfort to them during the ablution process. Furthermore, the design of the ablution station is user-friendly whereby the wheelchair user remains seated on the wheelchair and no longer rely on others for assistance. The support means (4) can be selected from a group of hinge mechanism.

In second embodiment, the remote, oscillating and multidirectional features of the fountain water system (15) ensure stand-alone washing of the feet allow wheelchair users to perform ablution process without extra effort and discomfort. The stand-alone feature is defined by using a water controller (14) to control the water flow from the water inlet (16) to the fountain water system(15). These features are essential to make sure all the lower part of the user's body especially the feet are covered by the water. Optionally, a bidet (13) is extended from the water inlet (16) for convenient use of the user. The double layer features of the bottom base (2) is designed to avoid water ponding and the used water will flow out of the ablution station by an outlet (20) and preferably a hole.

In third embodiment, the ablution station is a ready-to-assemble concept of installation to avoid the expensive installation and renovation of the existing facilities.

Although the invention has been described with reference to particular embodiment, it is to be understood that the embodiment is merely illustrative of the principles and applications of the present invention. It is therefore to be understood that numerous modifications may be made to the illustrative embodiment that other arrangements may be devised without departing from the scope of the present invention as defined by the appended claim.

1. A portable and moveable ablution station comprising:
a support structure having a vertical platform and a bottom base;
a washing platform is connected to an upper part of the vertical platform by a support means;
an opening between the washing platform and the vertical platform for allowing water to flow from the washing platform to the bottom base;
a fountain water system is fixed at the bottom base of the support structure for washing lower part of a user's body;
a water inlet for allowing water flow from a water source is directed to the washing platform and to the fountain water system wherein a water tap is mounted on the washing platform for washing upper part of the user's body;
a water controller is provided to control water flow from the water inlet to the fountain water system; and
a water outlet for allowing water drain from the ablution station.

2. A portable and movable ablution station as claimed in claim 1, wherein the upper washing platform is designed ergonomically to prevent water from overspilling and suit for disable user with a wheelchair.

3. A portable and movable ablution station as claimed in claim 1, wherein the upper washing platform is transparent.

4. A portable and movable ablution station as claimed in claim 1, wherein the fountain water system is multidirectional to cover all lower part of the user's body.

5. A portable and movable ablution station as claimed in claim 1, wherein the fountain water system is remotable and oscillated.

6. A portable and movable ablution station as claimed in claim 1, wherein the bottom base is double layer base to avoid water ponding.

7. A portable and movable ablution station as claimed in claim 1, wherein the water controller is arranged on the washing platform.

8. A portable and movable ablution station as claimed in claim 1, wherein the ablution station is ready-to assemble concept of installation.

9. A portable and movable ablution station as claimed in claim 2, wherein the upper washing platform is transparent.

10. A portable and movable ablution station as claimed in claim 4, wherein the fountain water system is remotable and oscillated.
